(19) United States
(12) Patent Application Publication
(10) Pub. No.: US 2021/0169150 A1
(43) Pub. Date: Jun. 10, 2021

(54) Dual Battery Electronic Cigarette

(71) Applicant: JT International S.A., Geneva (CH)

(72) Inventor: Claude Zominy, Copponex (FR)

(73) Assignee: JT International S.A., Geneva (CH)

(21) Appl. No.: 17/270,299

(22) PCT Filed: Sep. 12, 2019
(86) PCT No.: PCT/EP2019/074330

§ 371 Date: Feb. 22, 2021

(30) Foreign Application Priority Data
Sep. 24, 2018 (EP) 18196169.9

(51) Int. Cl. A24F 40/90; A24F 40/46; A24F 40/50; H02J 7/00

(52) U.S. Cl. CPC A24F 40/90; A24F 40/46; A24F 40/10; H02J 7/0013; A24F 40/50

(57) ABSTRACT

An electronic cigarette has an electrical heater for heating an aerosol forming substrate to generate an inhalable aerosol. Control circuitry is provided to control the supply of electrical power to the electrical heater. A first battery has a first operating voltage, when fully charged, which is above a first threshold, and the first battery supplies electrical power to the control circuitry when in use. A second battery has a second operating voltage, when fully charged, which is below the first threshold, and the second battery supplies electrical power to the electrical heater, when in use.

### CROSS-REFERENCE TO RELATED APPLICATIONS

The present application is a national phase entry under 35 U.S.C. § 371 of International Application No. PCT/EP2019/074330, filed Sep. 12, 2019, published in English, which claims priority to European Application No. 18196169.9 filed Sep. 24, 2018, the disclosures of which are incorporated herein by reference.

### BACKGROUND OF THE INVENTION

The present invention relates to a dual battery system for use in an electronic cigarette.

Electronic cigarettes are becoming increasingly popular consumer devices. Some electronic cigarettes are provided with a liquid reservoir that stores a vaporisable liquid. A flow path is provided from the liquid reservoir to a vaporiser, which is sometimes referred to as an atomiser. Often an atomiser is provided with a wick or absorber that can absorb liquid from the reservoir and a heating coil that can vaporise the liquid that is received in the absorber. These heating coils are often provided as electrically resistive wires that are wrapped around the absorber.

Other electronic cigarettes are provided with conventional tobacco and a heater that can heat the tobacco without burning it. These electronic cigarettes can also generate an inhalable vapour for a user.

Typically electronic cigarettes are provided with a rechargeable battery. A full battery charge allows a period of use, after which the device must be recharged. Typically an electronic cigarette has control circuitry for controlling the supply of electrical power to the heater. Typically, the rechargeable battery is designed to supply power both to the control circuitry and to the electrical heater.

One example of an aerosol-generating device is described in US 2017/0215477 A1. This document describes an aerosol-generating device having a first power supply configured to supply electrical energy only to an electric heater and a second power supply configured to supply electrical energy to a controller that controls the supply of electrical energy from the first power supply to the electric heater. Separating the supply of electrical energy to the heater and the controller has been adopted in this arrangement to facilitate the use of a measure of the electrical energy remaining in the first power supply as an indication of a level of consumption of an aerosol-forming substrate. It has been found that this kind of arrangement is not necessarily effective for all types of battery.

### BRIEF SUMMARY OF THE INVENTION

One object of the present invention is to provide an electronic cigarette that can be used with a wider variety of battery types.

According to an aspect of the present invention there is provided an electronic cigarette comprising: an electrical heater for heating an aerosol forming substrate to generate an inhalable aerosol; control circuitry configured to control the supply of electrical power to the electrical heater; a first battery having a first operating voltage, when fully charged, which is above a first threshold, wherein the first battery is electrically connected to the control circuitry and is configured to supply electrical power to the control circuitry when in use; and a second battery having a second operating voltage, when fully charged, which is below the first threshold, wherein the second battery is electrically connected to the electrical heater and is configured to supply electrical power to the electrical heater, when in use.

The electronic cigarette requires control circuitry so that it can be operated. However, the control circuitry has voltage requirements that cannot be met by all available battery types. The present technique allows an electronic cigarette to be provided with the second battery that can power the electrical heater, but which has an operating voltage that is below a threshold voltage that would be required to power the control circuitry. Thus, the first battery can be provided with an operating voltage that is above the first threshold to power the control circuitry and the second battery can power the electrical heater, but the second battery can be provided with a lower operating voltage since it is not required to power the control circuitry. This allows an electronic cigarette to be produced with a wider range of battery types.

The first threshold may be in the range of 3-3.3V. Preferably the first threshold is close to 3.3V because this is the threshold voltage that is required for effective operation of the control circuitry. Preferably the control circuitry includes a processor such as a microcontroller having a minimum voltage requirement which is above the first threshold.

The second operating voltage of the second battery, when fully charged, is preferably below a second threshold and the second threshold is less than the first threshold. In this way, the first operating voltage and the second operating voltage can be spaced apart from one another. The second threshold may be in the range of 2.5-3V. Preferably the second operating voltage is around 2.6V as this is the operating voltage of some desirable battery types, such as Lithium Titanate Oxide (LTO) batteries.

The control circuitry may comprise a voltage multiplier configured to transform the voltage supplied to the electrical heater by the second battery. The voltage multiplier is preferably electrically powered by the first battery and transforms the voltage output from the second battery. The voltage multiplier can transform the voltage from the second battery to reach a suitable voltage for supplying power to the electrical heater. The voltage required by the electrical heater may vary depending on the required properties of the heater. One preferred kind of voltage multiplier is a buck converter.

A voltage multiplier may not be required in all embodiments. For example, where the electrical heater is a low resistance coil it may be possible to provide effective heating using a low voltage input, without any voltage transformation.

The first battery has a first charge capacity and the second battery has a second charge capacity which is preferably larger than the first charge capacity. In this way the charge capacity of the second battery can exceed that of the first battery. The power requirements of the electrical heater are typically higher than those of the control circuitry and therefore the second battery is generally larger than the first battery.

The first charge capacity of the first battery provides a first operational duration and the second charge capacity of the second battery provides a second operational duration, during normal use of the electronic cigarette. It would be undesirable, in normal use, for the first battery to be depleted before the second battery as this would render the electronic cigarette unusable, even though charge remains in the second battery. Therefore, the first operational duration is preferably equal to or larger than the second operational duration.

The second battery may be a Lithium-ion battery, such as a Lithium Titanate Oxide, LTO, battery. The first battery may have a different chemistry to the second battery. Any convenient chemistry may be chosen for the first battery based on performance, weight, size and cost considerations.

The first and second batteries are preferably rechargeable and the electronic cigarette preferably comprises charging circuitry. The charging circuitry preferably comprises first and second integrated circuits for the first and second batteries, respectively. The first and second integrated circuits are preferably respectively connected to a common electrical charging input. In this way, a single charging port can be provided and the electrical power supplied from this port can charge the first and second batteries, via the first and second integrated circuits.

The control circuitry may include a feedback from the electrical heater or sensors associated with the electrical heater or the aerosol forming substrate so that the supply of electrical power to the electrical heater is at least partially dependent on feedback signals.

The electronic cigarette may include the aerosol forming substrate. For example, the electronic cigarette may include a vaporisable liquid within a liquid reservoir or the electronic cigarette may include a tobacco charge that can be heated by the electrical heater.

According to another aspect of the invention there is provided a method of operating an electronic cigarette which includes an electrical heater for heating aerosol forming substrate to generate an inhalable aerosol, control circuitry configured to control the supply of electrical power to the electrical heater, a first battery, and a second battery, wherein the method comprises the steps of: supplying electrical power to the control circuitry from the first battery, wherein the first battery has a first operating voltage, when fully charged, that is above a first threshold; and supplying electrical power to the electrical heater from the second battery, wherein the second battery has a second operating voltage, when fully charged, which is below the first threshold.

### BRIEF DESCRIPTION OF THE DRAWINGS

Embodiments of the invention are now described, by way of example, with reference to the drawings, in which:

FIG. 1A is a front perspective view of an electronic cigarette in an embodiment of the invention;

FIG. 1B is a rear perspective view of the electronic cigarette shown in FIG. 1A;

FIG. 10 is a cross-sectional view of the electronic cigarette shown in FIG. 1A;

FIG. 2 is a schematic circuit diagram showing components of an electronic cigarette in an embodiment of the invention;

FIG. 3 is another schematic circuit diagram showing components of an electronic cigarette in an embodiment of the invention;

FIG. 4A is a front perspective view of an electronic cigarette in another embodiment of the invention;

FIG. 4B is a rear perspective view of the electronic cigarette shown in FIG. 4A; and

FIG. 4C is a cross-sectional view of the electronic cigarette shown in FIG. 4A.

### DETAILED DESCRIPTION

As used herein, the term “inhaler” or “electronic cigarette” may include an electronic cigarette configured to deliver an aerosol to a user, including an aerosol for smoking. An aerosol for smoking may refer to an aerosol with particle sizes of 0.5-7 microns. The particle size may be less than 10 or 7 microns. The electronic cigarette may be portable.

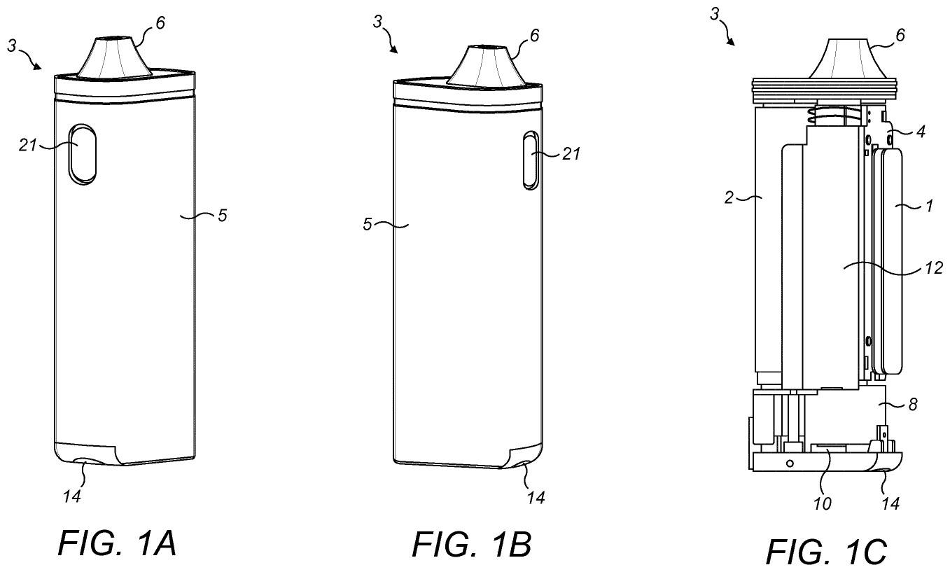

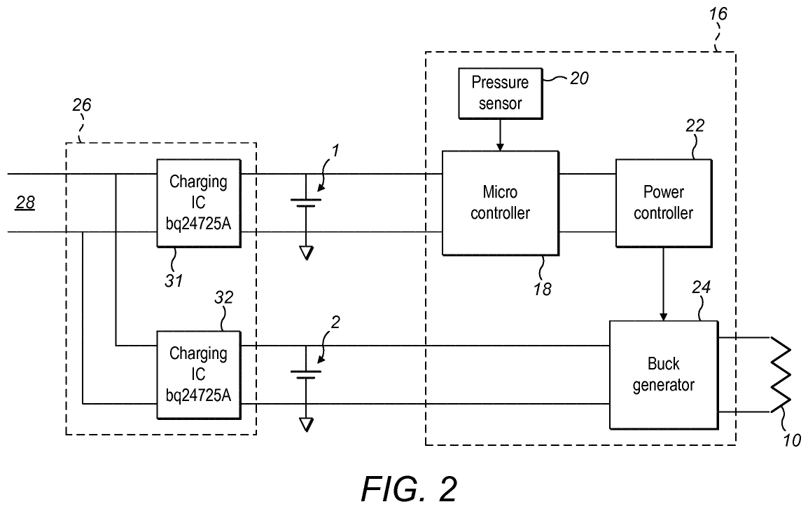

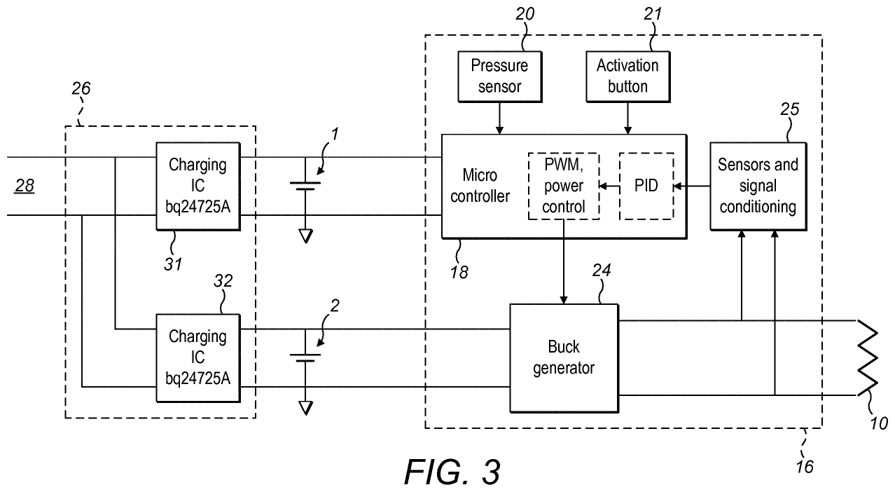

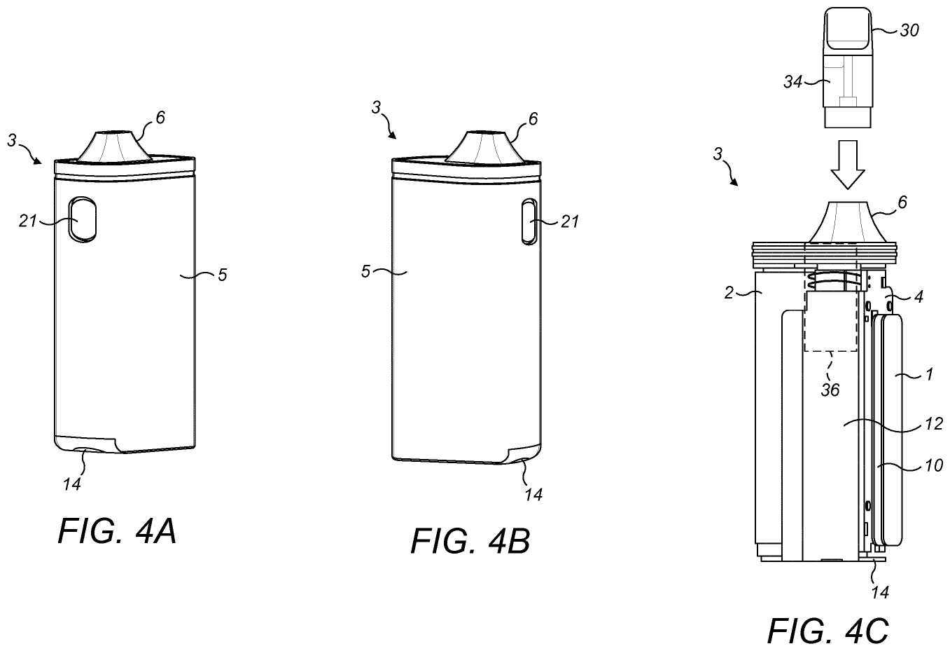

FIGS. 1A-1C show an electronic cigarette 3 in an embodiment of the invention. The electronic cigarette 3 can be used as a substitute for a conventional cigarette comprising shredded tobacco. The electronic cigarette 3 comprises an elongate main body 5, a mouthpiece portion 6 and an oven 8 for receiving a stick of tobacco (not shown). The oven 8 includes an electrical heater 10 that can heat the stick of tobacco without burning it, and generate vapour.

A vapour channel 12 is provided and extends between the oven 8 and the mouthpiece portion 6. The mouthpiece portion 6 is tip-shaped to correspond to the ergonomics of the user's mouth. The electronic cigarette additionally includes an air inlet 14 in fluid communication with the mouthpiece portion 6 and the vapour channel 12, whereby a user drawing on the mouthpiece portion 6 causes air to flow into the air inlet 14 and through the oven 8 and the vapour channel 12 to the mouthpiece portion 6. An activation button 21 is provided with which a user can control the production of vapour by the electrical heater 10.

The electronic cigarette includes a first battery 1 and a second battery 2 electrically connected to a printed circuit board (PCB) 4 which includes control circuitry. The first battery 1 is configured to supply electrical power to the PCB 4 and the control circuitry connected thereto. The second battery 2 is configured to supply electrical power to the electrical heater 10, under the control of the control circuitry in the PCB 4. In one example, the first battery 1 is a LCO (Lithium Cobalt Oxide) prismatic battery with a soft pouch, which is also known as a Li-polymer battery. In this example, the first battery 1 has dimensions of around 30×15×7 mm, with a capacity of 200-300 mAh and provides an operating voltage when fully charged of around 3.7V. In one example, the second battery 2 is a LTO (Lithium Titanate Oxide) cylindrically shaped battery with a capacity of 1100 mAh and provides an operating voltage when fully charged of around 2.4V. The capacity of the second battery 2 is significantly higher than that of the first battery 1 because the electrical heater 10 that is powered by the second battery 2 has higher power requirements than the control circuitry that is powered by the first battery 1.

FIG. 2 is a schematic circuit diagram showing electrical components within the electronic cigarette 3 described above. The circuit diagram includes the first battery 1 and the second battery 2. The first battery 1 supplies electrical power to a microcontroller 18 on the PCB 4, within a control system 16. The microcontroller 18 must be powered by a power source having a voltage above a first threshold, which is around 3.3V, if it is to operate effectively. The first battery 1 is chosen specifically so that it can supply the microcontroller 18 with a suitable power supply, and the first battery provides an operating voltage when fully charged of around 3.7V, which is above the first threshold.

The control system 16 also includes a pressure sensor 20. The pressure sensor 20 is configured to measure the pressure in the vapour channel 12 of the electronic cigarette 3 and to provide signals to the microcontroller 18. The microcontroller 18 can therefore provide a signal to activate the electrical heater 10 when the pressure sensor 20 senses a reduction in pressure that is associated with a user drawing on the mouthpiece 6. As an alternative to a pressure sensor 20 a simple activation push button 21 may be provided which the user can depress in order to operate the heater 10.

The microcontroller 18 is connected to a power controller 22 on the PCB 4. The power controller 22 is configured to provide pulse width modulation control signals to a buck generator 24, which acts as a voltage converter, positioned between the second battery 2 and the electrical heater 10.

The second battery 2 is configured to supply electrical power to the electrical heater 10. The buck generator 24 is positioned between the second battery 2 and the electrical heater 10 and acts as a voltage multiplier. The buck generator 24 transforms the voltage output from the second battery, which is around 2.4V (and is below the first threshold described above), to the voltage that is required for normal operation of the electrical heater 10. The precise voltage required is dependent on the properties of the electrical heater 10 that is chosen. In one embodiment the buck generator 24 can be based on a CSD95377 circuit from Texas Instruments; alternatively, a discrete system may be provided which is synchronous or non-synchronous.

A charging system 26 is also provided for the first and second batteries 1, 2, which are rechargeable in this embodiment. A power supply port is provided in the form of a USB port 28. A first charging integrated circuit (IC) 31 is provided for the first battery 1 and a second charging IC 32 is provided for the second battery 2. In this example embodiment the first and second charging ICs 31, 32 are based on the bq24725A IC from Texas Instruments, which can support batteries having different chemistries.

In use, a power cable is connected to the USB port 28 and the first and second batteries 1, 2 are charged by the charging system 26. When fully charged the first battery 1 provides a voltage output of around 3.7V, which is above the first threshold and is therefore high enough to power the microcontroller 18 in the control system 16. The control system 16 becomes active once it receives an appropriate power supply from the first battery 1. The active control system 16 is ready to activate the heater 10 once a suitable pressure drop is detected by the pressure sensor 20. Upon detection of an appropriate pressure drop by the pressure sensor 20, the microcontroller 18 sends a signal to the power controller 22 which can control the supply of electrical power from the second battery 2 to the electrical heater 10, via the buck generator 24. The buck generator 24 can transform the voltage output from the second battery 2, which is around 2.4V, to a higher voltage as required by the electrical heater 10.

It is notable that the second battery 2 provides an output voltage of around 2.4V, which is below the first threshold required for operation of the microcontroller 18 and is also below a second threshold of 2.6V. It would not be possible to activate the control system 16 by using the voltage output from the second battery 2. Equally, it would not be possible to transform the voltage from the second battery 2 in order to supply a signal to the microcontroller 18 because such a transformation would need to be performed through a control system that would also require a minimum operating voltage. The present arrangement enables use of a second battery 2 for supplying power only to the electrical heater 10 which has a voltage below the threshold value required for operation of the microcontroller 18. This facilitates use of an electronic cigarette 3 with a wider variety of batteries, including LTO batteries which have many desirable properties, but which often provide a low voltage output.

FIG. 3 is a schematic circuit diagram for components within the electronic cigarette 3 in an alternative embodiment of the invention. In this embodiment the microcontroller 18 can receive input signals from the pressure sensor 20 and the activation button 21. The microcontroller 18 can therefore control operation of the electrical heater 10 based on depression of the activation button 21 or detection of a pressure drop by the pressure sensor 20, as described previously. In this example embodiment the microcontroller 18 includes an integrated power controller which is connected to the buck generator 24.

The control system 16 also includes sensors 25 that can be used for feedback control. Example sensors include temperature sensors, coil resistance sensors and moisture sensors for determining moisture content in the vaporisable material. Measurements from one or more sensors 25 can be provided to an integrated PID controller in the microcontroller 18. The signals from the one or more sensors 25 can be used to control the power supplied to the electrical heater 10 by the second battery 2.

FIGS. 4A-4C show an electronic cigarette 3 in another embodiment of the invention. In this example embodiment the vaporisable medium is a liquid, rather than a stick of tobacco. A capsule 30 includes a reservoir 34 for storing a vaporisable liquid. The cartridge 30 includes an integrated electrical heater (not shown) which can be supplied with electrical power to vaporise the vaporisable liquid for inhalation by a user. In use, the cartridge 30 is accommodated within a receiving portion 36 at the upper end of the electronic cigarette 3. The vaporisable liquid may be propylene glycol or glycerin, which is able to produce a visible vapor. The vaporisable liquid may further comprise other substances such as nicotine and flavorings. As an alternative to a cartridge the reservoir may be configured as a refillable “open tank” reservoir.

In a liquid-based electronic cigarette an electric heater can be provided as a low resistance coil which can be operated even with low voltages. A titanium coil may be used, for example, having very low resistivity of perhaps 10, or less. Therefore, it may not be necessary to use a buck converter in these embodiments. A control system is still necessary, however, in these embodiments.

1. An electronic cigarette comprising:
an electrical heater for heating an aerosol forming substrate to generate an inhalable aerosol;
control circuitry configured to control the supply of electrical power to the electrical heater;
a first battery having a first operating voltage, when fully charged, which is above a first threshold, wherein the first battery is electrically connected to the control circuitry and is configured to supply electrical power to the control circuitry when in use; and
a second battery having a second operating voltage, when fully charged, which is below the first threshold, wherein the second battery is electrically connected to the electrical heater and is configured to supply electrical power to the electrical heater, when in use.

2. The electronic cigarette of claim 1, wherein the first threshold is in the range of 3-3.3V.

3. The electronic cigarette of claim 1, wherein the second operating voltage of the second battery, when fully charged, is below a second threshold and the second threshold is less than the first threshold.

4. The electronic cigarette of claim 3, wherein the second threshold is in the range of 2.5-3V.

5. The electronic cigarette of claim 1, wherein the control circuitry comprises a voltage multiplier configured to transform the voltage supplied to the electrical heater by the second battery.

6. The electronic cigarette of claim 1, wherein the first battery has a first charge capacity and the second battery has a second charge capacity which is larger than the first charge capacity.

7. The electronic cigarette of claim 6, wherein first charge capacity of the first battery provides a first operational duration and the second charge capacity of the second battery provides a second operational duration, during normal use of the electronic cigarette, wherein the first operational duration is equal to or larger than the second operational duration.

8. The electronic cigarette of claim 1, wherein the second battery is a Lithium-ion battery, such as a Lithium Titanate Oxide, LTO, battery.

9. The electronic cigarette of claim 1, wherein the first and second batteries are rechargeable and the electronic cigarette comprises charging circuitry.

10. The electronic cigarette of claim 9, wherein the charging circuitry comprises first and second charging integrated circuits for the first and second batteries, respectively.

11. The electronic cigarette of claim 10, wherein the first and second charging integrated circuits are respectively connected to a common electrical charging input.

12. The electronic cigarette of claim 1, wherein the control circuitry includes feedback from the electrical heater or sensors associated with the electrical heater so that the supply of electrical power to the electrical heater is at least partially dependent on the feedback.

13. A method of operating an electronic cigarette which includes an electrical heater for heating an aerosol forming substrate to generate an inhalable aerosol, control circuitry configured to control the supply of electrical power to the electrical heater, a first battery, and a second battery, wherein the method comprises the steps of:
supplying electrical power to the control circuitry from the first battery, wherein the first battery has a first operating voltage, when fully charged, that is above a first threshold; and
supplying electrical power to the electrical heater from the second battery, wherein the second battery has a second operating voltage, when fully charged, which is below the first threshold.
